(19) United States
(12) Patent Application Publication
(10) Pub. No.: US 2006/0080085 A1
(43) Pub. Date: Apr. 13, 2006

(54) System and method for making information queries and for sending and mediating information

(76) Inventor: Teet Kalmus, Estonia (EE)

Correspondence Address: BIRCH STEWART KOLASCH & BIRCH, PO BOX 747, FALLS CHURCH, VA, 22040-0747, US

(21) Appl. No.: 11/224,940

(22) Filed: Sep. 14, 2005

Related U.S. Application Data
(60) Provisional application No. 60/609,835, filed on Sep. 15, 2004.

(51) Int. Cl. G10L 11/00

(52) U.S. Cl. 704/200

(57) ABSTRACT

A method and system for making location-based information queries, including a mobile phone, mobile phone masts, an information centre, comprised of a server and data base, companies offering mobile communications services, short message centres, information lines and catalogues and information contained in data bases, software controlling the information net and relevant information regarding people included in data bases. Relevant software controls the information query compiled in the mobile phone and sent in the form of a short message to the information centre, finding an answer to this query and forwarding it to the information querier. The information querier can determine the language of the query answer, not depending on the location, and get any information of his/her interest in his/her native language, for example, or any other acceptable language.

### FIELD OF THE INVENTION

The present invention belongs to the sphere of info technological and telecommunications applications or more precisely to the sphere of data communications and information sending and mediating solutions. Whereas determining the language of answers to the queries is either location-based or can be changed according to the information querier's choice.

### STATE OF THE ART

Various mediating and information sending solutions are well-known. For example international patent application WO 2004036932 and European patent application EP 1271908 describe sending and mediating information via SMS and MMS short messages using mobile phones and the Internet.

Various location determining and positioning solutions are known as well. For example use of digital maps to determine the location of a vehicle via a GSM mobile phone SMS-query, GPS-GSM controller and a PC, which is described in the home page of Infors Group OÜ, which has the following address: http://www.infors.ee/.

Various location-based positioning and finding the nearest objects, sights, etc., via mobile phone WAP and SMS services and the Internet are also known and described in the home page of Regio AS, which has the following address: http://www.regio.ee/?op=body&id=43.

Implementation of the solution and use by the end-user is too complicated, which is also the shortcoming of the solution. In order to send a query regarding some shops, hotels, restaurants, bars, etc., the information querier must know various codes or insert long texts into the mobile phone. Not depending on the language the query was sent in, there is no possibility to get an answer in the language of one's choice.

### BACKGROUND OF THE INVENTION

In order to make information queries and send and mediate information using the system and method of the present invention, existing solutions and applications have been joined together (for example digital map, MMS, GPS, GPRS, etc.) and the global network is used to prevent the earlier mentioned shortcomings. The aim of the present invention is to offer the user or in other words information querier a possibility to get information all through the world in the chosen language (for example in one's native language) either via mobile phone communication short message (SMS, MMS, etc.) or other mobile technology means (WAP, G3, etc.).

Using an information network, the information querier can get information of one's interest not depending on the location either in one's native language or any other acceptable language.

A short message, SMS for example, the information querier sends to the information centre enables the server to generate an answer in the language chosen by the information querier. The information querier has to insert data about the choice of the language either automatically or manually. The information centre consists of a server, which controls information movement via mobile phone, mobile phone communications mast and database.

Automatic determination of the query language is executed through the language used in the mobile phone at this moment. In case of manual determination of the language, a numerical code corresponding to the chosen language will be inserted within the short message.

The short message sent by the information querier includes information that enables the computer to determine the location of the information querier. The location is determined either automatically or manually.

The location is determined automatically via the location code that the information querier sends to the server within his/her short message and which the mobile communications masts receive from the mobile phones located in their distribution area. The received code enables the server to determine the location of the mobile communications mast that in its turn determines the location of the information querier.

Manual determination of the location is executed via coordinates received by GPS or information sent to the server by the mobile phone menu. In case of manual determination of the location via the menu of the mobile phone, information showing the location of the information querier is chosen from the subdirectory (for example “country”-“county-“town”-“street”) and sent to the server.

After determination of the geographical location of the information querier, the server will find needed information and scans it circle by circle further from the location centre of the information querier.

The short message sent by the information querier includes an information query that enables the server to generate an answer with the information asked for by the information querier. Let's assume that the information querier has asked for the closest catering establishment in the neighbourhood opened at the present moment. With the help of the software integrated into the mobile phone, entry word “catering establishment” is chosen. For more precise definition of the information query “catering establishment” new entry words “restaurant,” “pub,” “bar,” etc., are chosen from the sub-directory.

The information querier receives a short message to his/her mobile phone that contains answers to the sent information query. The answer contains information about an establishment, event, etc., of interest for the information querier, for example a name, location (place name, street name, etc.), geographical coordinates, information phone number and in which language the information is available, opening hours or at what time the event takes place, etc. Information sent as an answer may contain a mobile link that enables further information to be received about an event, shop, etc. To receive additional information it is enough to activate the mobile link. Within the present invention the mobile link means something similar to an Internet page, where a click on the link opens a new Internet page window on the computer screen.

Software created for the work of the information network controls the work of the server and enables the information querier to compile an information query in his/her mobile phone that would be understandable for the server.

Every region has an appointed cooperation partner who is responsible for the relevant and duly made changes into the information contained in the franchise-based established database. Use of entry words makes it possible to receive answers in different languages without any translation distortions, which means that the queries and answers are expressed in entry words. Entry words enable the limited data communications capacity resources to be used in the optimal manner.

### BRIEF DESCRIPTION OF DRAWINGS

FIG. 1 up to FIG. 4 on the drawing depicts various implementation examples of the information network in the form of a block diagram based on the present invention, where:

FIG. 1 on the drawing depicts an information query being sent in case of automatic determination of a language and location,

FIG. 2 on the drawing depicts an information query being sent in case of manual determination of a language and location,

FIG. 3 on the drawing depicts an information query being sent in case of manual determination of a language and automatic determination of a location,

FIG. 4 on the drawing depicts an information query being sent in case of manual determination of a language and automatic determination of a location.

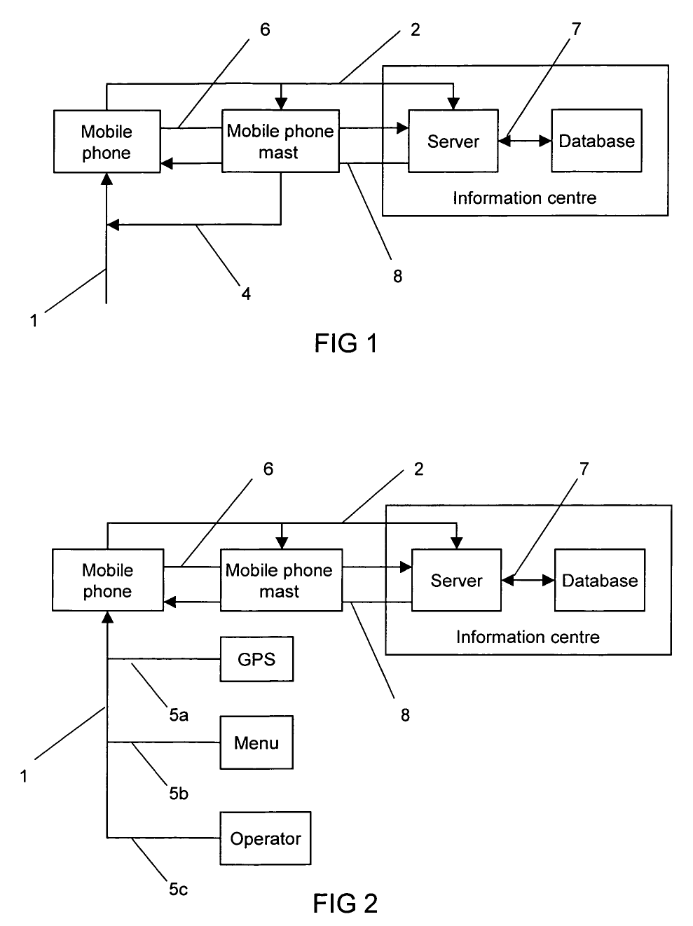

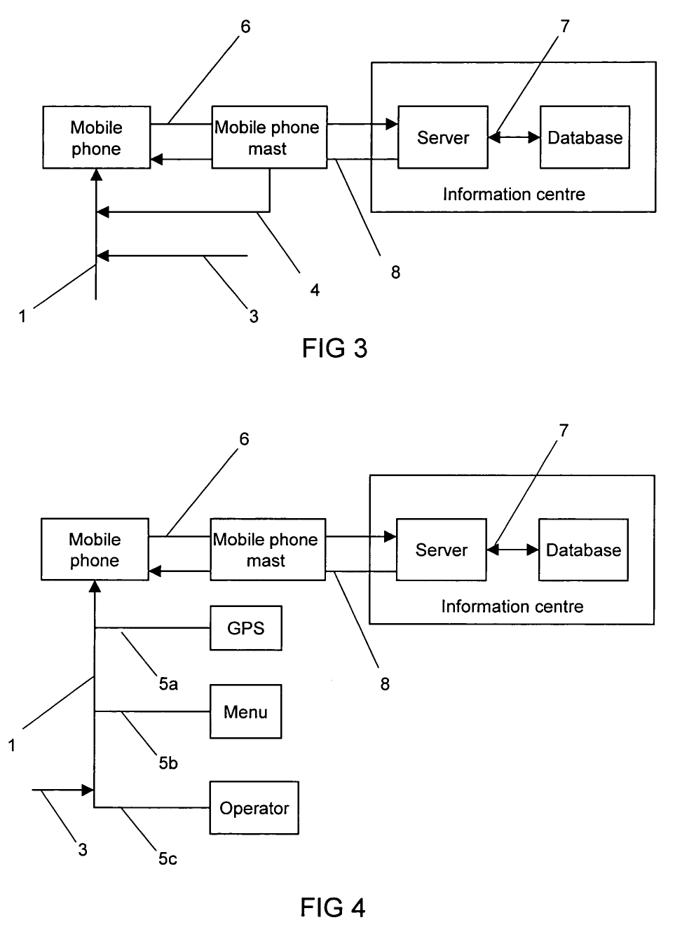

### EXAMPLE OF IMPLEMENTATION

The technical solution of the present invention includes a mobile phone, mobile phone masts, an information centre comprised of a server and data base, involving also companies offering mobile communications services, short message centres, information lines and catalogues and information contained in data bases.

Relevant software controls an information query compiled in the mobile phone and sent to the information centre in the form of a short message, finding an answer to the received query and forwarding the answer to the information querier. Thanks to the software that controls sending short messages, information mediating and forwarding, there is no need for customer service personnel, operators, etc., which helps to save costs.

The information network established for performing information queries and for sending and mediating information from the systems and methods based on the present invention comprises inserting an information query into the mobile phone 1, an automatic determination of the language of the answer to the query 2, a manual determination of the language of the answer to the query 3, an automatic determination of the location 4 and a manual determination of the location via GPS coordinates 5a, via choosing the location from the menu of the mobile phone 5b, via the company offering mobile communications services 5c and using the location determining system of the mobile phone, sending a query to the information centre 6, finding an answer from the data base by the server 7, sending an answer to the mobile phone 8.

The short message compiled in the process of making an information query is sent to the information centre, where an answer to the query generated by the software is sent in the form of a short message via a mobile communications operator, through which the message was received, back into the mobile phone. Thus two short messages are sent during one session of an information query.

In order to implement the method based on the invention, the work of an information network is controlled by software that consists of at least two programmes. One programme controls the work of the server and the second enables the information querier to compile an information query in his/her mobile phone that would be understandable for the server. The system work is based on various information servers that are linked to a united system that prevents possible disturbances caused by a failure of one or another server.

According to the other implementation example, execution of an information query in the framework of the method of the present invention on the basis of a name of a village or street, towns and streets should be given individual codes, entry of which would enable the computer to determine the location of the information query. At the same time use of such a code book (or internet page with different codes) might be too clumsy. To solve the above, the author of the present invention offers the following solution. While located in the country, codes of towns-villages (from geographical atlases for example) followed by the name of the street have to be inserted into the mobile phone using the local orthography. This solution is possible but considering the ease of use, the simplest way is to use a method that determines the location of the information querier either automatically or via GPS coordinates.

Business Model

In order to implement the global information network, a franchise-based economic model has to be used. A holding company supervises the server net and software, and data bases will be filled with necessary information by cooperation partners, who sell their service on the basis of franchise contracts: they use the trademark of the holding company, software solutions, data collecting methodology and business model developed by the holding company. Their profit will be generated by the certain percentage of the turnover.

An already established entry word-based translation programme can also be used in other business spheres. For example a software programme could be developed that would enable the restaurant customer to translate the menu into his/her native language using a blackboard computer and to order food knowing exactly what the order consists of. It is also possible to install order automats into fast food restaurants, bars, etc., where customers can give orders in their native language.

1. A system for making information queries and for sending and mediating information, including a mobile phone, mobile phone masts, an information centre, comprised of a server and data base, companies offering mobile communications services, short message centres, information lines and catalogues and information contained in data bases, software controlling the information net and relevant information regarding people included in data bases characterized in that the answer to the information query is determined by the location of the information querier and the answer to the information query is generated in the language chosen by the information querier.

2. A system for making information queries and for sending and mediating information according to claim 1 characterized in that the way that the language of the answer to the information query is automatically determined.

3. A system for making information queries and for sending and mediating information according to claim 1 characterized in that the way that the language of the answer to the information query is manually determined.

4. A system for making queries and for sending and mediating information according to claim 1 characterized in that the way that the location of the information querier is automatically determined.

5. A system for making queries and for sending and mediating information according to claim 1 characterized in that the way that the location of the information querier is manually determined.

6. A system for making queries and for sending and mediating information according to claim 5 characterized in that the way that the location of the information querier is determined by the information chosen from the sub-directory menu of the mobile phone.
